(19) United States
(12) Patent Application Publication
(10) Pub. No.: US 2012/0312441 A1
(43) Pub. Date: Dec. 13, 2012

(54) PNEUMATIC RADIAL TIRE FOR USE ON PASSENGER CAR

(75) Inventor: Shinya Harikae, Kanagawa (JP)

(73) Assignee: The Yokohama Rubber Co., Ltd., Tokyo (JP)

(21) Appl. No.: 13/490,540

(22) Filed: Jun. 7, 2012

(30) Foreign Application Priority Data
Jun. 7, 2011 (JP) 2011-127596

(51) Int. Cl. B60C 9/28

(52) U.S. Cl. 152/527

(57) ABSTRACT

A pneumatic radial tire for use on passenger cars including two layers of a belt layer formed from steel cords embedded at an angle from 15° to 45° with respect to a tire circumferential direction. The belt layers are formed from steel cords formed from a non-twisted steel monofilament having a diameter from 0.27 mm to 0.45 mm. A belt auxiliary layer formed from steel cords embedded at an angle from 80° to 90° with respect to the tire circumferential direction is provided between a carcass layer and the belt layers.

### PRIORITY CLAIM

Priority is claimed to Japan Patent Application Serial No. 2011-127596 filed on Jun. 7, 2011.

### BACKGROUND

1. Technical Field

The present technology relates to a pneumatic radial tire for use on passenger cars, and particularly relates to a pneumatic radial tire for use on passenger cars in which a high level of durability can be maintained and rolling resistance can be reduced.

2. Related Art

Generally, pneumatic radial tires for use on passenger cars have a structure in which a carcass layer, including a plurality of carcass cords oriented in a tire radial direction, is mounted between a pair of bead portions and a belt layer, including a plurality of steel cords inclined with respect to a tire circumferential direction, is disposed on an outer circumferential side of the carcass layer in a tread portion. There are societal demands for saving resources and saving energy, and these have led to a strong demand for a pneumatic radial tire for use on passenger cars by which increased fuel efficiency of a vehicle can be achieved. As a result of this demand, in recent years, much effort has been made in the development of fuel-efficient tires having reduced rolling resistance.

An example of a method to reduce rolling resistance is to reduce the weight of the tire. Specifically, a reassessment of the configuration of belt cords used in the belt layer is being conducted. For example, as belt cords, using cords made from monofilaments instead of cords made by twisting together a plurality of filaments has been proposed (e.g. see Japanese Unexamined Patent Application Publication No. H08-300905A). In cases where a monofilament belt cord is used, it is possible to reduce the thickness of the belt layer and, therefore, the weight of the tire can be reduced. As a result, the rolling resistance can be reduced.

However, steel cords formed from monofilaments have poor fatigue resistance with respect to flexing and, therefore, while the rolling resistance can be reduced in cases where such cords are used in the belt layer, there is a problem in that durability sufficient for a pneumatic tire cannot be obtained.

### SUMMARY

The present technology provides a pneumatic tire in which tire durability can be maintained and rolling resistance can be reduced even in cases where a monofilament belt cord is used.

A pneumatic radial tire for use on passenger cars of the present technology includes a carcass layer mounted between left and right bead portions; and two layers of a belt layer formed from steel cords embedded at an angle from 15° to 45° with respect to a tire circumferential direction in a periphery of the carcass layer in a tread portion, disposed so that cord directions between the two layers cross each other. Additionally, the belt layers are formed from steel cords that are formed from a non-twisted steel monofilament having a diameter from 0.27 mm to 0.45 mm. Moreover, a belt auxiliary layer formed from steel cords embedded at an angle from 80° to 90° with respect to the tire circumferential direction is provided between the carcass layer and the belt layers.

With the present technology, the gauge of the belt layers is reduced and, thus, rolling resistance can be reduced due to the belt layers being formed from steel cords that are formed from a non-twisted steel monofilament having a diameter from 0.27 mm to 0.45 mm. Furthermore, a belt auxiliary layer formed from steel cords embedded at an angle from 80° to 90° with respect to the tire circumferential direction is provided between the carcass layer and the belt layers. Therefore buckling of the belt cords is suppressed and a reduction in fatigue resistance with respect to flexing accompanying the use of the monofilament can be compensated for. As a result, both a reduction in the rolling resistance and an improvement in tire durability can be achieved.

In the present technology, the belt auxiliary layer is preferably formed from steel cords embedded at an angle from 87° to 90° with respect to the tire circumferential direction. Thereby, the rolling resistance can be reduced even further.

In the present technology, the belt auxiliary layer is preferably disposed so that at least a portion of the belt auxiliary layer is provided at positions 30 mm toward an inner side in a tire width direction from each end of the belt layer having a smallest width of the belt layers. By disposing the belt auxiliary layer as described above, buckling of the belt cords can be effectively suppressed.

In the present technology, a strength of the steel monofilament constituting the belt layers is preferably not less than 2,700 MPa, and a product of a cross-sectional area of the steel monofilament constituting the belt layers and a thread count per 50 mm unit width is preferably not less than 4.5 mm² and not more than 6.8 mm². Alternatively, the strength of the steel monofilament constituting the belt layers is preferably not less than 3,200 MPa, and the product of the cross-sectional area of the steel monofilament constituting the belt layers and the thread count per 50 mm unit width is preferably not less than 4.5 mm² and not more than 6.1 mm². Alternatively, the strength of the steel monofilament constituting the belt layers is preferably not less than 3,500 MPa, and the product of the cross-sectional area of the steel monofilament constituting the belt layers and the thread count per 50 mm unit width is preferably not less than 4.5 mm² and not more than 5.5 mm². Thus, the product of the cross-sectional area of the steel monofilament constituting the belt layers and the thread count is defined based on the strength of the steel filament constituting the belt layers. As a result, strength and cord abundance can be balanced and both superior durability and superior adhesion can be achieved.

In the present technology, a bundle including from two to five cords arranged in the tire width direction of the steel monofilament constituting the belt layers is preferably disposed as a unit in the belt layers. By disposing such a bundle as the unit, a substantial wire pitch between the bundles within the belt layers (pitch between bundles) widens. Therefore, progression of belt-edge-separation can be retarded and separation resistance can be enhanced.

In the present technology, the steel cords constituting the belt auxiliary layer are preferably formed by twisting together two or more wires. Thus, a stranded wire having superior interwire friction attenuating properties is used between the belt layers and the carcass layer and, therefore, riding comfort can be enhanced.

In the present technology, the belt auxiliary layer is preferably divided in the tire width direction and a width of each section of the belt auxiliary layer is preferably not less than 30 mm. Furthermore, a separation distance between the sections of the belt auxiliary layer is preferably not less than 20% of the width of the belt layer having the smallest width of the belt layers. With such a divided structure, weight of the tire can be reduced without negatively affecting durability.

In the present technology, a coat compound constituting the belt layers is preferably formed from a rubber composition having a dynamic elastic modulus E′ at 20° C. of not more than 15 MPa and a tan δ at 60° C. of not more than 0.15. In cases when a belt portion is formed in the tread portion having a three-layer structure including two layers of the belt layer and one layer of the belt auxiliary layer, contributions of the coat compound to the rigidity of the belt portion decrease. Therefore, a coat compound that is soft and in which heat buildup is low can be used for the belt layers. As a result, heat buildup in the belt layers can be suppressed and durability can be further enhanced.

Note that “dynamic elastic modulus E′ at 20° C.” refers to a dynamic elastic modulus measured using a viscoelastic spectrometer (manufactured by Toyo Seiki Seisaku-sho, Ltd.) under the following conditions: Temperature=20° C.; Frequency=20 Hz; Initial distortion=10%; Dynamic distortion=±2%. “Tan δ at 60° C.” refers to a tan δ measured using a viscoelastic spectrometer (manufactured by Toyo Seiki Seisaku-sho, Ltd.) under the following conditions: Temperature=60° C.; Frequency=20 Hz; Initial distortion=10%; Dynamic distortion=+2%.

### BRIEF DESCRIPTION OF THE DRAWINGS

FIG. 1 is a meridian cross-sectional view of a pneumatic radial tire for use on passenger cars according to an embodiment of the present technology.

FIG. 2 is a meridian cross-sectional view of a pneumatic radial tire for use on passenger cars according to another embodiment of the present technology.

FIG. 3 is a main constituent expanded view in which a carcass layer, belt layers, and a belt auxiliary layer of the pneumatic radial tire for use on passenger cars depicted in FIG. 1 are extracted and illustrated.

FIG. 4 is a main constituent expanded view in which a carcass layer, belt layers, and a belt auxiliary layer of the pneumatic radial tire for use on passenger cars depicted in FIG. 2 are extracted and illustrated.

FIGS. 5A and 5B are cross-sectional views in which the belt layer of the pneumatic radial tire for use on passenger cars of the present technology is enlarged and illustrated.

### DETAILED DESCRIPTION

Detailed descriptions will be given below of a configuration of the present technology with reference to the accompanying drawings.

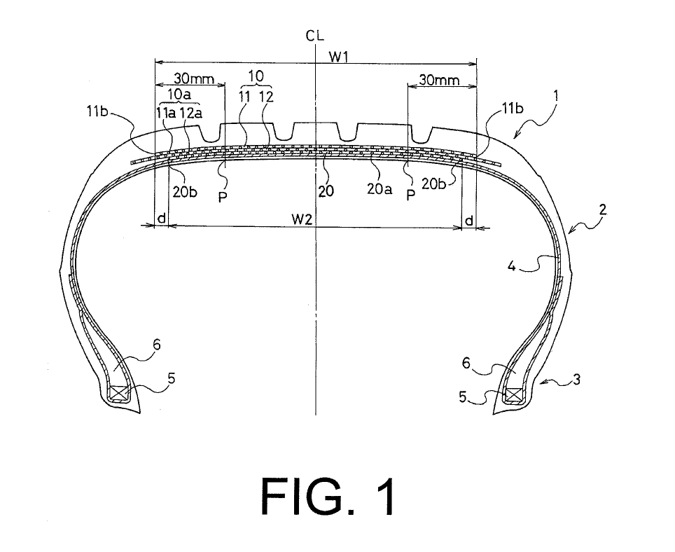

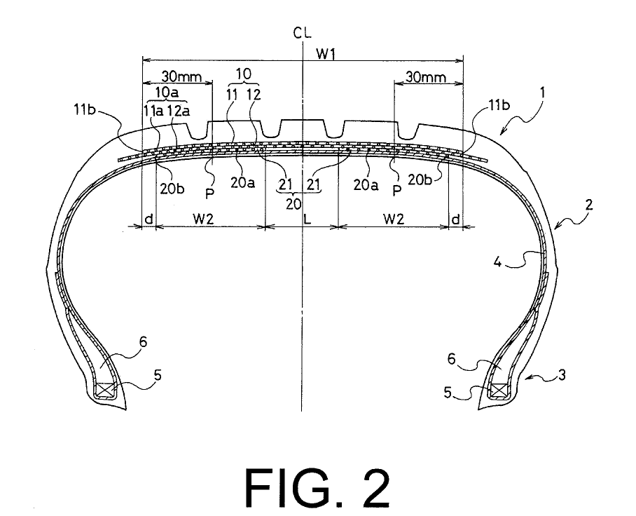

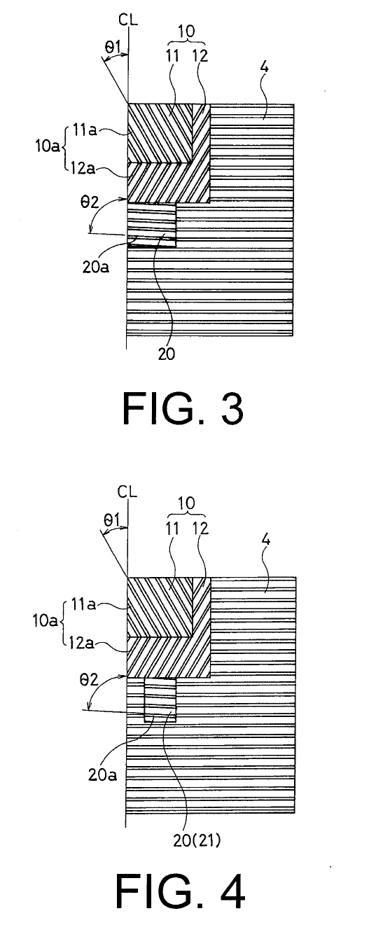

FIGS. 1 and 2 illustrate pneumatic radial tires for use on passenger cars according to embodiments of the present technology (hereinafter referred to as “tires”). Additionally, FIGS. 3 and 4 are expanded drawings (illustrating only one side from a tire equatorial plane CL) in which a carcass layer 4, belt layers 10, and a belt auxiliary layer 20 of the tires of FIGS. 1 and 2 are extracted and illustrated.

In FIGS. 1 and 2, 1 is a tread portion, 2 is a side wall portion, and 3 is a bead portion. One layer of the carcass layer 4 is mounted between a pair of left and right bead portions 3,3. Ends of the carcass layer 4 are folded around bead cores 5 from a tire inner side to a tire outer side. A bead filler 6 having a triangular cross-sectional shape formed from rubber is disposed on an outer circumferential side of the bead cores 5. Two layers of the belt layer 10 (11 and 12) are disposed throughout an entirety of a circumference of the tire on the outer circumferential side of the carcass layer 4 in the tread portion 1. As illustrated in FIGS. 3 and 4, these belt layers 10 (11 and 12) are formed by embedding belt cords 10a (11a and 12a) formed from steel cords in the rubber. These belt cords 10a (11a and 12a) are inclined at a low angle with respect to a tire circumferential direction, and said inclination angle θ1 is from 15° to 45°. Additionally, these belt cords 11a and 12a are disposed so as to cross each other.

The belt cords 10a (11a and 12a) are formed from a non-twisted steel monofilament having a diameter from 0.27 mm to 0.45 mm. By setting the diameter of the belt cord 10a that constitutes the belt layers 10 to be small, a gauge of the belt layers 10 is reduced and, thus, rolling resistance can be reduced. Note that generally, an unformed filament is used for the non-twisted steel monofilament, but a formed filament may also be used.

In a pneumatic tire configured as described above, a belt auxiliary layer 20 is disposed between the carcass layer 4 and the belt layers 10. As illustrated in FIGS. 3 and 4, the belt auxiliary layer 20 is formed by embedding belt auxiliary cords 20a that are formed from steel cords in the rubber. These belt auxiliary cords 20a are inclined at a high angle with respect to the tire circumferential direction, and said inclination angle θ2 is from 80° to 90° and preferably from 87° to 90°. By providing the belt auxiliary layer 20 described above, buckling of the belt cords 10a is suppressed and a reduction in fatigue resistance with respect to flexing accompanying the use of the monofilament can be compensated for. As a result, both a reduction in the rolling resistance and an improvement in tire durability can be achieved.

If the inclination angle θ1 of the belt cords 10a (11a and 12a) is less than 15°, rigidity in a width direction of the belt portion will be insufficient, which will lead to a decline in steering stability. If the inclination angle θ1 of the belt cords 10a (11a and 12a) is greater than 45°, circumferential rigidity of the belt portion will be insufficient, which will lead to a decline in steering stability.

If the diameter of the belt cords 10a is less than 0.27 mm, it will be necessary to increase a thread density in order to maintain durability. As a result, adhesion will decline and edge-separation durability will decline. If the diameter of the belt cords 10a is greater than 0.45 mm, reduction effects of the gauge of the belt layers 10 will be insufficient. As a result, the fatigue resistance with respect to flexing of the cords will decline and belt breakage durability will be negatively affected. If the inclination angle θ2 of the belt auxiliary cords 20a is less than 80°, the rigidity in the width direction of the belt portion will be insufficient, which will lead to a decline in steering stability.

Note that if the belt auxiliary layer 20 is disposed between the belt layer 11 and the belt layer 12 or outward in a radial direction of the outermost belt layer 11, the rolling resistance cannot be sufficiently reduced.

As illustrated in FIGS. 1 and 3, the belt auxiliary layer 20 can be provided on an inner circumferential side of the belt layers 10 so as to cover an entirety of the tire width direction. Additionally, as illustrated in FIGS. 2 and 4, the belt auxiliary layer 20 may be configured from two sections 21,21 that are divided in the tire width direction and separated by a tire center portion.

In either case, the belt auxiliary layer 20 is preferably disposed so that at least a portion of the belt auxiliary layer 20 is provided at positions P 30 mm toward an inner side in the tire width direction from each end 11b,11b of the belt layer 11 having a smallest width of the belt layers 10. In other words, ends 20b on outer sides in the tire width direction of the belt auxiliary layer 20 are preferably positioned inward in the tire width direction of ends 11b of the belt layer 11 having the smallest width of the belt layers 10; and a separation distance d between the ends 20b on outer sides in the tire width direction of the belt auxiliary layer 20 and the ends 11b of the belt layer 11 having the smallest width is preferably 30 mm or less, respectively.

By disposing the belt auxiliary layer 20 at the position described above, buckling of the belt cords 10a can be effectively suppressed. In cases where the belt auxiliary layer 20 does not extend to a position P or, rather, in cases where the separation distance d between the ends 20b on outer sides in the tire width direction of the belt auxiliary layer 20 and the ends 11b of the belt layer 11 having the smallest width is greater than 30 mm, durability will decline because it will not be possible to sufficiently reinforce sites that are prone to belt breakage.

In cases where the belt auxiliary layer 20 is configured so as to be divided in the tire width direction into the sections 21,21 as illustrated in FIGS. 2 and 4, a width measured in the tire width direction of each of the sections 21,21 is preferably not less than 30 mm. Furthermore, a separation distance L between the sections 21,21 of the belt auxiliary layer 20 is preferably not less than 20% of a width W1 of the belt layer 11 having the smallest width of the belt layers 10. The separation distance L is more preferably not less than 20% and not more than 60% of the width W1 of the belt layer 11 having the smallest width.

In cases where the belt auxiliary layer 20 is divided, weight of the tire can be reduced without negatively affecting durability by disposing each of the sections 21 as described above. If the width of each of the sections is less than 30 mm, the belt layers 10 cannot be sufficiently reinforced and, as a result, durability will decline. Additionally, if the separation distance L between the sections 21,21 is less than 20% of the width W1 of belt layer 11 having the smallest width, it will not be possible to sufficiently reduce the amount of the belt auxiliary layer 20 and, as a result, a sufficient effect of reducing the weight of the tire will not be obtained.

Note that in cases when a belt auxiliary layer 20 is provided that covers the entire width as illustrated in FIG. 1, the width of the belt auxiliary layer 20 is not particularly limited provided that the belt auxiliary layer 20 extends to the position P described above. In other words, in this case, it is sufficient that the width of the belt auxiliary layer 20 be equal to or greater than the length between the left and right positions P. Specifically, the width of the belt auxiliary layer 20 is preferably greater than W1 minus 60 mm.

In the tire of the present technology configured as described above, an abundance of the belt cords 10a can be reduced by increasing the strength of the belt cords 10a (11a and 12a) and, thus, the weight of the tire can be further reduced. Rather, by configuring the strength of the steel monofilament constituting the belt cords 10a to be within an appropriate range, and by configuring the product of the cross-sectional area of the steel monofilament constituting the belt cords 10a and the thread count per 50 mm unit width to be within an appropriate range, a balance can be achieved between the strength and the abundance of the belt cords 10a, and the weight of the tire can be even further reduced while maintaining the durability at a high level.

Specifically, the strength of the steel monofilament constituting the belt layers 10 is preferably not less than 2,700 MPa, and a product of a cross-sectional area of the steel monofilament constituting the belt layers 10 and a thread count per 50 mm unit width is preferably not less than 4.5 mm² and not more than 6.8 mm². Alternatively, the strength of the steel monofilament constituting the belt layers 10 is preferably not less than 3,200 MPa, and the product of the cross-sectional area of the steel monofilament constituting the belt layers 10 and the thread count per 50 mm unit width is preferably not less than 4.5 mm² and not more than 6.1 mm². Alternatively, the strength of the steel monofilament constituting the belt layers 10 is preferably not less than 3,500 MPa, and the product of the cross-sectional area of the steel monofilament constituting the belt layers 10 and the thread count per 50 mm unit width is preferably not less than 4.5 mm² and not more than 5.5 mm².

Regardless of the range of the strength, if the product of the cross-sectional area of the steel monofilament constituting the belt layers 10 and the thread count per 50 mm unit width is less than 4.5 mm², the abundance of the belt cords 10a will be excessively small, rigidity will be insufficient, and durability will decline. In cases where the strength is 2,700 MPa or greater and the product of the cross-sectional area and the thread count is greater than 6.8 mm², the strength is 3,200 MPa or greater and the product of the cross-sectional area and the thread count is greater than 6.1 mm², or the strength is 3,500 MPa or greater and the product of the cross-sectional area and the thread count is greater than 5.5 mm², the abundance of the belt cords 10a will exceed the amount needed to sufficiently maintain the durability within each strength range. As a result, the amount of wire will be excessive, which will lead to an increase in mass, and the cord pitch will be narrowed, which will lead to insufficient adhesion. Thus, the durability of the tire will decline. Furthermore, energy loss of the belt rubber will increase, which will inhibit the reduction of the rolling resistance. In cases where the strength is less than 2,700 MPa, it will be necessary to configure the product of the cross-sectional area and the thread count to be greater than 6.8 mm² in order to obtain durability. As a result, the amount of wire will increase, which will lead to an increase in mass, and the cord pitch will be narrowed, which will lead to insufficient adhesion. Thus, the durability of the tire will decline.

Note that the higher the strength of the steel monofilament constituting the belt layers 10 is, the more the product of the cross-sectional area and the thread count or, rather, the abundance of the belt cords 10a can be reduced and the more the weight of the tire can be reduced. However, from the perspective of manufacturing, the strength is preferably not greater than 4,200 MPa.

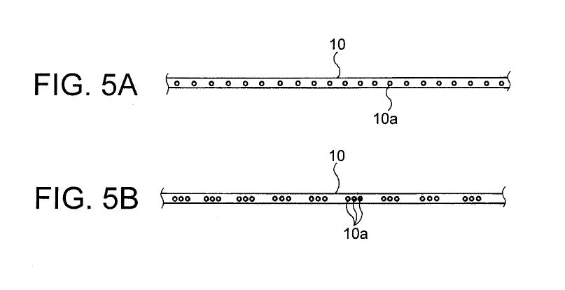

In the present technology, the belt cords 10a that constitute the belt layers 10 are disposed in a state of mutual alignment. The belt cords 10a may, for example, as illustrated in FIG. 5A, be disposed at equal spacing in the tire width direction in a meridian cross-section. However, preferably, as illustrated in FIG. 5B, bundles of two to five cords aligned in the tire width direction in a meridian cross-section (three cords in the drawing) are disposed in the belt layers 10 as a unit.

With such an arrangement, the space between each bundle within the belt layers 10 is substantially the wire pitch, and the wire pitch is greater than cases where the cords are disposed at equal intervals. Therefore, progression of belt-edge-separation can be retarded and separation resistance can be enhanced. Here, if the number of cords constituting the bundle of the belt cords 10a is greater than five, belt-edge-separation progression will be promoted.

In the present technology, the belt auxiliary cords 20a constituting the belt auxiliary layer 20 may be formed from a monofilament, but preferably are formed by twisting two or more wires together, and more preferably by twisting two to seven wires together. Particularly, cords having a 1×N structure are preferably used.

With the present technology, because the belt layers 10 are formed from a monofilament, there is a tendency for the belt layers 10 to become rigid, attenuating interwire friction to be difficult, and the riding comfort to decline. However, because the belt auxiliary layer 20 is configured as described above, the twisted cords formed by twisting two or more wires together will have superior interwire friction attenuating properties and, therefore, riding comfort can be enhanced. Preferably, twisted cords are used that are formed by twisting two to seven wires together.

Additionally, the thread count of the belt auxiliary cords 20a constituting the belt auxiliary layer 20 is preferably configured so as to be from 15 to 35 cords/50 mm. If the thread count of the belt auxiliary cords 20a is less than 15 cords/50 mm, it will be difficult to suppress the buckling of the belt cords. While a maximum effect of suppressing belt buckling will be obtained if the thread count of the belt auxiliary cords 20a exceeds 35 cords/50 mm, mass will also increase.

With the present technology, as described above, a three-layer belt portion including two layers of the belt layer 10 (11 and 12) and one layer of the belt auxiliary layer 20 is formed in the tread portion. Therefore, contributions of the coat compound to the rigidity of the belt portion decrease. As a result, a coat compound that is soft and in which heat buildup is low can be used for the belt layers 10. Thus, heat buildup in the belt layers 10 can be suppressed and the durability can be further enhanced.

Specifically, a coat compound constituting the belt layers 10 preferably has a dynamic elastic modulus E′ at 20° C. of not more than 15 MPa and a tan δ at 60° C. of not more than 0.15. If the dynamic elastic modulus F at 20° C. of the coat compound exceeds 15 MPa, the heat buildup in the belt layers 10 cannot be reduced and durability enhancement effects cannot be sufficiently obtained. If the tan δ at 60° C. of the coat compound exceeds 0.15, the heat buildup in the belt layers 10 cannot be reduced and durability enhancement effects cannot be sufficiently obtained.

Note that with the coat compound of the belt auxiliary layer 20, just as with the coat compound of the belt layers 10, contribution of the coat compound to the rigidity of the belt portion is reduced and a coat compound that is soft and in which heat buildup is low can be used. As a result, heat buildup in the belt layers 10 can be suppressed and the durability can be further enhanced. Therefore, preferably a coat compound having the same dynamic elastic modulus E′ and tan δ as the belt layers is used.

### Working Examples

24 types of test tires were fabricated for Conventional Examples 1 and 2, Comparative Examples 1 to 4, and Working Examples 1 to 18. Each of these test tires was a pneumatic tire with a tire size of 195/65R15. For the belt layers, a number of belt layers and arrangement, structure, strength, thread volume, thread count, diameter, dynamic elastic modulus E′ at 20° C., and tan δ at 60° C. of the belt cords were configured for each test tire as shown in Tables 1 to 3. For the belt auxiliary layer, presence/absence and arrangement of the belt auxiliary layer; structure and angle of the belt auxiliary cords; arrangement form, layer width, and presence/absence of overlap with the position P of the belt auxiliary layer; and thread count of the belt reinforcing cords were configured for each test tire as shown in Tables 1 to 3.

Conventional Examples 1 and 2 were tires that did not include a belt auxiliary layer. In Conventional Example 1, the belt layers were formed from twisted cords (strength: 3,100 MPa) having a 1×3×0.32 structure (thread density: 27 cords/50 mm unit width). In Conventional Example 2, the belt layers were formed from monofilaments (strength: 3,100 MPa) having a wire diameter of 0.32 mm (thread density: 81 cords/50 mm unit width).

The tires of Comparative Examples 1 to 4 included belt auxiliary layers. In Comparative Example 1, the cord angle of the belt auxiliary cords was small. In Comparative Example 2, the arrangement of the belt auxiliary cords differed. In Comparative Examples 3 and 4, the diameter of the belt cords was outside the range of the present technology.

Note that the belt layers of the 24 types of test tires for Conventional Examples 1 and 2, Comparative Examples 1 to 4, and Working Examples 1 to 18 each had equivalent thread volumes, and widths of the main belt layers in order from the tire inner surface side were 150 mm and 135 mm.

Additionally, the belt auxiliary layers of the 22 types of test tires for Comparative Examples 1 to 4, and Working Examples 1 to 18 where each formed from twisted cords (strength: 3,100 MPa) having a 1×3×0.32 structure (thread density: 27 cords/50 mm unit width).

Belt breakage durability (normal conditions), belt breakage durability (severe conditions), belt-edge-separation durability, and rolling resistance were evaluated according to the methods described below and recorded in Tables 1 to 3 for each of the 22 types of test tires.

### Belt Breakage Durability (Normal Conditions)

A drum test machine having a smooth, steel drum surface and a diameter of 1,707 mm was used, and ambient temperature was controlled to 38±3° C. The test tires were assembled on a rim having a rim size of 15×6J, and inflated to an internal test pressure of 160 kPa. Then the test tires were run for 10 hours and 300 km under the following conditions while varying the load and slip angle using a 0.083 Hz square waveform: Running speed: 30 km/hr, Slip angle: 0±4°, Load: 70%±40% variable of the maximum load designated by JATMA (Japan Automobile Tire Manufacturers Association). After the running, the tires were cut open and the belt cords were examined for the presence/absence of failures. Results were evaluated using a two-choice system in which examples where belt cord failure occurred were indicated with a “x” and examples where belt cord failure did not occur were indicated with a “∘”.

### Belt Breakage Durability (Severe Conditions)

A drum test machine having a smooth, steel drum surface and a diameter of 1,707 mm was used, and ambient temperature was controlled to 38±3° C. The test tires were assembled on a rim having a rim size of 15×6J, and inflated to an internal test pressure of 160 kPa. Then the test tires were run for 10 hours and 300 km under the following conditions while varying the load and slip angle using a 0.083 Hz square waveform: Running speed: 30 km/hr, Slip angle: 0±5°, Load: 70%±40% variable of the maximum load designated in the JATMA Year Book 2009. After the running, the tires were cut open and the belt cords were examined for the presence/absence of failures. Results were evaluated using a two-choice system in which examples where belt cord failure occurred were indicated with a “x” and examples where belt cord failure did not occur were indicated with a “∘”.

### Belt-Edge-Separation Durability

The test tires were assembled on a rim having a rim size of 15×6J and inflated with oxygen to an internal pressure of 240 kPa and stored for two weeks in a chamber having a room temperature maintained at 60° C. Then, the oxygen inside was released and the tires were filled with air to 160 kPa. A drum test machine having a smooth, steel drum surface and a diameter of 1,707 mm was used, and ambient temperature was controlled to 38±3° C. The test tires pretreated as described above were run for 100 hours and 5,000 km under the following conditions while varying the load and slip angle using a 0.083 Hz square waveform: Running speed: 50 km/hr, Slip angle: 0±3°, Load: 70%±40% variable of the maximum load designated in the JATMA Year Book 2009. After the running, the tires were cut open and confirmation of the presence/absence of a separated portion having a separation length in the width direction of 5 mm or greater in the end portion in the width direction of the belt was conducted. The absence of belt separation indicates that belt-edge-separation durability is superior. Results were evaluated using a two-choice system in which examples where a separated portion with a length of 5 mm or greater was present were indicated with a “x” and examples where a separated portion with a length of 5 mm or greater was absent were indicated with a “∘”.

### Rolling Resistance

Using a drum test machine having a smooth, steel drum surface and a diameter of 1,707 mm, the test tires, being assembled on rims having a rim size of 15×6J and inflated to an internal pressure of 200 kPa, were loaded with a load equivalent to 85% of the maximum load at said air pressure as designated in the JATMA Year Book 2009 and pressed against the drum. In this state, the rolling resistance of the test tires was measured at a running speed of 80 km/hr. Measurement results were expressed as an index with the measured value for Conventional Example 1 being 100. Smaller index values indicate less rolling resistance.

TABLE 1

| | | Conventional | Conventional | Comparative | Working |
|---|---|---|---|---|---|
| | | Example 1 | Example 2 | Example 1 | Example 1 |
| Belt layers | Number of layers | 2 | 2 | 2 | 2 |
| | Cord arrangement | FIG. 5A | FIG. 5A | FIG. 5A | FIG. 5A |
| | Cord structure | 1 × 3 | Monofilament | Monofilament | Monofilament |
| | Cord strength (MPa) | 2,700 | 2,700 | 2,700 | 2,700 |
| | Thread volume | 4.50 | 4.50 | 4.50 | 4.50 |
| | (mm²/50 mm) | | | | |
| | Thread count | 56.0 | 56.0 | 56.0 | 56.0 |
| | (cords/50 mm) | | | | |
| | Cord diameter (mm) | 0.32 | 0.32 | 0.32 | 0.32 |
| | Dynamic elastic | 20 | 20 | 20 | 20 |
| | modulus E′ (MPa) | | | | |
| | Tan δ | 0.20 | 0.20 | 0.20 | 0.20 |
| Belt | Presence/absence | Absent | Absent | Present | Present |
| auxiliary | Arrangement | — | — | Under belt | Under belt |
| layer | Cord structure | — | — | 1 × 3 | 1 × 3 |
| | Cord angle (°) | — | — | 55 | 80 |
| | Arrangement form | — | — | Entire width | Entire width |
| | Layer width | — | — | 115 | 115 |
| | Presence/absence of | — | — | Present | Present |
| | overlap with the | | | | |
| | position P | | | | |
| | Thread count | — | — | 30 | 30 |
| | (cords/50 mm) | | | | |
| Evaluation | Belt breakage | ∘ | x | ∘ | ∘ |
| | durability (normal | | | | |
| | conditions) | | | | |
| | Belt breakage | ∘ | x | ∘ | ∘ |
| | durability (severe | | | | |
| | conditions) | | | | |
| | Belt-edge-separation | ∘ | x | x | ∘ |
| | durability | | | | |
| | Rolling resistance | 100 | 95 | 98 | 96 |
| | (index) | | | | |

| | | Working | Working | Comparative | Comparative |
|---|---|---|---|---|---|
| | | Example 2 | Example 3 | Example 2 | Example 3 |
| Belt layers | Number of layers | 2 | 2 | 2 | 2 |
| | Cord arrangement | FIG. 5A | FIG. 5A | FIG. 5A | FIG. 5A |
| | Cord structure | Monofilament | Monofilament | Monofilament | Monofilament |
| | Cord strength (MPa) | 2,700 | 2,700 | 2,700 | 2,700 |
| | Thread volume | 4.50 | 4.50 | 4.50 | 4.50 |
| | (mm²/50 mm) | | | | |
| | Thread count | 56.0 | 56.0 | 56.0 | 56.0 |
| | (cords/50 mm) | | | | |
| | Cord diameter (mm) | 0.32 | 0.32 | 0.32 | 0.25 |
| | Dynamic elastic | 20 | 20 | 20 | 20 |
| | modulus E′ (MPa) | | | | |
| | Tan δ | 0.20 | 0.20 | 0.20 | 0.20 |
| Belt | Presence/absence | Present | Present | Present | Present |
| auxiliary | Arrangement | Under belt | Under belt | Above belt | Under belt |
| layer | Cord structure | 1 × 3 | 1 × 3 | 1 × 3 | 1 × 3 |
| | Cord angle (°) | 87 | 90 | 90 | 90 |
| | Arrangement form | Entire width | Entire width | Entire width | Entire width |
| | Layer width | 115 | 115 | 115 | 115 |
| | Presence/absence of | Present | Present | Present | Present |
| | overlap with the | | | | |
| | position P | | | | |
| | Thread count | 30 | 30 | 30 | 30 |
| | (cords/50 mm) | | | | |
| Evaluation | Belt breakage | ∘ | ∘ | ∘ | ∘ |
| | durability (normal | | | | |
| | conditions) | | | | |
| | Belt breakage | ∘ | ∘ | ∘ | ∘ |
| | durability (severe | | | | |
| | conditions) | | | | |
| | Belt-edge-separation | ∘ | ∘ | ∘ | x |
| | durability | | | | |
| | Rolling resistance | 95 | 95 | 98 | 95 |
| | (index) | | | | |

TABLE 2

| | | Working | Working | Comparative | Working |
|---|---|---|---|---|---|
| | | Example 4 | Example 5 | Example 4 | Example 6 |
| Belt layer | Number of layers | 2 | 2 | 2 | 2 |
| | Cord arrangement | FIG. 5A | FIG. 5A | FIG. 5A | FIG. 5A |
| | Cord structure | Monofilament | Monofilament | Monofilament | Monofilament |
| | Cord strength (MPa) | 2,700 | 2,700 | 2,700 | 2,700 |
| | Thread volume | 4.50 | 4.50 | 4.50 | 4.50 |
| | (mm²/50 mm) | | | | |
| | Thread count | 56.0 | 56.0 | 56.0 | 56.0 |
| | (cords/50 mm) | | | | |
| | Cord diameter (mm) | 0.27 | 0.45 | 0.50 | 0.32 |
| | Dynamic elastic | 20 | 20 | 20 | 20 |
| | modulus E′ (MPa) | | | | |
| | Tan δ | 0.20 | 0.20 | 0.20 | 0.20 |
| Belt | Presence/absence | Present | Present | Present | Present |
| auxiliary | Arrangement | Under belt | Under belt | Under belt | Under belt |
| layer | Cord structure | 1 × 3 | 1 × 3 | 1 × 3 | 1 × 3 |
| | Cord angle (°) | 90 | 90 | 90 | 90 |
| | Arrangement form | Entire width | Entire width | Entire width | Split |
| | Layer width | 115 | 115 | 115 | 25 |
| | Presence/absence of | Present | Present | Present | Present |
| | overlap with the | | | | |
| | position P | | | | |
| | Thread count | 30 | 30 | 30 | 30 |
| | (cords/50 mm) | | | | |
| Evaluation | Belt breakage | ∘ | ∘ | x | ∘ |
| | durability (normal | | | | |
| | conditions) | | | | |
| | Belt breakage | ∘ | ∘ | x | x |
| | durability (severe | | | | |
| | conditions) | | | | |
| | Belt-edge-separation | ∘ | ∘ | ∘ | ∘ |
| | durability | | | | |
| | Rolling resistance | 95 | 95 | 95 | 95 |
| | (index) | | | | |
| | | Working | Working | Working | Working |
| | | Example 7 | Example 8 | Example 9 | Example 10 |
| Belt layer | Number of layers | 2 | 2 | 2 | 2 |
| | Cord arrangement | FIG. 5A | FIG. 5A | FIG. 5A | FIG. 5A |
| | Cord structure | Monofilament | Monofilament | Monofilament | Monofilament |
| | Cord strength (MPa) | 2,700 | 2,700 | 2,700 | 3,100 |
| | Thread volume | 4.50 | 4.50 | 4.50 | 4.34 |
| | (mm²/50 mm) | | | | |
| | Thread count | 56.0 | 56.0 | 56.0 | 54.0 |
| | (cords/50 mm) | | | | |
| | Cord diameter (mm) | 0.32 | 0.32 | 0.32 | 0.32 |
| | Dynamic elastic | 20 | 20 | 20 | 20 |
| | modulus E′ (MPa) | | | | |
| | Tan δ | 0.20 | 0.20 | 0.20 | 0.20 |
| Belt | Presence/absence | Present | Present | Present | Present |
| auxiliary | Arrangement | Under belt | Under belt | Under belt | Under belt |
| layer | Cord structure | 1 × 3 | 1 × 3 | 1 × 3 | 1 × 3 |
| | Cord angle (°) | 90 | 90 | 90 | 90 |
| | Arrangement form | Split | Split | Split | Entire width |
| | Layer width | 30 | 50 | 30 | 115 |
| | Presence/absence of | Present | Present | Absent | Present |
| | overlap with the | | | | |
| | position P | | | | |
| | Thread count | 30 | 30 | 30 | 30 |
| | (cords/50 mm) | | | | |
| Evaluation | Belt breakage | ∘ | ∘ | ∘ | ∘ |
| | durability (normal | | | | |
| | conditions) | | | | |
| | Belt breakage | ∘ | ∘ | ∘ | ∘ |
| | durability (severe | | | | |
| | conditions) | | | | |
| | Belt-edge-separation | ∘ | ∘ | x | ∘ |
| | durability | | | | |
| | Rolling resistance | 95 | 95 | 95 | 95 |
| | (index) | | | | |

TABLE 3

| | | Working | Working | Working | Working |
|---|---|---|---|---|---|
| | | Example 11 | Example 12 | Example 13 | Example 14 |
| Belt layer | Number of layers | 2 | 2 | 2 | 2 |
| | Cord arrangement | FIG. 5A | FIG. 5A | FIG. 5A | FIG. 5A |
| | Cord structure | Monofilament | Monofilament | Monofilament | Monofilament |
| | Cord strength (MPa) | 3,100 | 3,100 | 3,100 | 3,100 |
| | Thread volume | 4.50 | 5.71 | 6.75 | 6.99 |
| | (mm²/50 mm) | | | | |
| | Thread count | 56.0 | 71.0 | 84.0 | 87.0 |
| | (cords/50 mm) | | | | |
| | Cord diameter (mm) | 0.32 | 0.32 | 0.32 | 0.32 |
| | Dynamic elastic | 20 | 20 | 20 | 20 |
| | modulus E′ (MPa) | | | | |
| | Tan δ | 0.20 | 0.20 | 0.20 | 0.20 |
| Belt | Presence/absence | Present | Present | Present | Present |
| auxiliary | Arrangement | Under belt | Under belt | Under belt | Under belt |
| layer | Cord structure | 1 × 3 | 1 × 3 | 1 × 3 | 1 × 3 |
| | Cord angle (°) | 90 | 90 | 90 | 90 |
| | Arrangement form | Entire width | Entire width | Entire width | Entire width |
| | Layer width | 115 | 115 | 115 | 115 |
| | Presence/absence of | Present | Present | Present | Present |
| | overlap with the | | | | |
| | position P | | | | |
| | Thread count | 30 | 30 | 30 | 30 |
| | (cords/50 mm) | | | | |
| Evaluation | Belt breakage | ∘ | ∘ | ∘ | ∘ |
| | durability (normal | | | | |
| | conditions) | | | | |
| | Belt breakage | ∘ | ∘ | ∘ | ∘ |
| | durability (severe | | | | |
| | conditions) | | | | |
| | Belt-edge-separation | ∘ | ∘ | ∘ | ∘ |
| | durability | | | | |
| | Rolling resistance | 95 | 95 | 95 | 95 |
| | (index) | | | | |
| | | Working | Working | Working | Working |
| | | Example 15 | Example 16 | Example 17 | Example 18 |
| Belt layer | Number of layers | 2 | 2 | 2 | 2 |
| | Cord arrangement | FIG. 5A | FIG. 5A | FIG. 5B | FIG. 5A |
| | Cord structure | Monofilament | Monofilament | Monofilament | Monofilament |
| | Cord strength (MPa) | 3,300 | 3,600 | 3,100 | 3,100 |
| | Thread volume | 4.50 | 4.50 | 4.50 | 4.50 |
| | (mm²/50 mm) | | | | |
| | Thread count | 56.0 | 56.0 | 56.0 | 56.0 |
| | (cords/50 mm) | | | | |
| | Cord diameter (mm) | 0.32 | 0.32 | 0.32 | 0.32 |
| | Dynamic elastic | 20 | 20 | 20 | 10 |
| | modulus E′ (MPa) | | | | |
| | Tan δ | 0.20 | 0.20 | 0.20 | 0.10 |
| Belt | Presence/absence | Present | Present | Present | Present |
| auxiliary | Arrangement | Under belt | Under belt | Under belt | Under belt |
| layer | Cord structure | 1 × 3 | 1 × 3 | 1 × 3 | 1 × 3 |
| | Cord angle (°) | 90 | 90 | 90 | 90 |
| | Arrangement form | Entire width | Entire width | Entire width | Entire width |
| | Layer width | 115 | 115 | 115 | 115 |
| | Presence/absence of | Present | Present | Present | Present |
| | overlap with the | | | | |
| | position P | | | | |
| | Thread count | 30 | 30 | 30 | 30 |
| | (cords/50 mm) | | | | |
| Evaluation | Belt breakage | ∘ | ∘ | ∘ | ∘ |
| | durability (normal | | | | |
| | conditions) | | | | |
| | Belt breakage | ∘ | ∘ | ∘ | ∘ |
| | durability (severe | | | | |
| | conditions) | | | | |
| | Belt-edge-separation | ∘ | ∘ | ∘ | ∘ |
| | durability | | | | |
| | Rolling resistance | 95 | 95 | 95 | 95 |
| | (index) | | | | |

It is clear from Tables 1 to 3 that with each of Working Examples 1 to 18, compared with Conventional Examples 1 and 2 that did not include the belt auxiliary layer, rolling resistance was greatly reduced while belt breakage durability (normal conditions) and belt-edge-separation durability were maintained at high levels. Particularly, with Working Examples 8 and 10 to 18, it was possible to enhance belt breakage durability under severe conditions as well as normal conditions.

On the other hand, with Comparative Example 1 in which the cord angle of the belt auxiliary cords was small and Comparative Example 2 in which the arrangement of the belt auxiliary cords differed, it was not possible to sufficiently reduce the rolling resistance; and in Comparative Examples 3 and 4 in which the diameter of the belt cords was outside the range of the present technology, it was not possible to maintain belt breakage durability or belt-edge-separation durability.

What is claimed is:

1. A pneumatic radial tire for use on passenger cars comprising: a carcass layer mounted between left and right bead portions; and two layers of a belt layer comprising steel cords embedded at an angle from 15° to 45° with respect to a tire circumferential direction in a periphery of the carcass layer in a tread portion, disposed so that cord directions between the layers cross each other, wherein
the belt layers are formed from steel cords comprising a non-twisted steel monofilament having a diameter from 0.27 mm to 0.45 mm, and a belt auxiliary layer comprising steel cords embedded at an angle from 80° to 90° with respect to the tire circumferential direction is provided between the carcass layer and the belt layers.

2. The pneumatic radial tire for use on passenger cars according to claim 1, wherein the belt auxiliary layer comprises steel cords embedded at an angle from 87° to 90° with respect to the tire circumferential direction.

3. The pneumatic radial tire for use on passenger cars according to claim 1, wherein the belt auxiliary layer is disposed so that at least a portion of the belt auxiliary layer is provided at positions 30 mm toward an inner side in the tire width direction from each end of a belt layer having a smallest width of the belt layers.

4. The pneumatic radial tire for use on passenger cars according to claim 1, wherein a strength of the steel monofilament constituting the belt layers is not less than 2,700 MPa, and a product of a cross-sectional area of the steel monofilament constituting the belt layers and a thread count per 50 mm unit width is not less than 4.5 mm² and not more than 6.8 mm².

5. The pneumatic radial tire for use on passenger cars according to claim 1, wherein a strength of the steel monofilament constituting the belt layers is not less than 3,200 MPa, and a product of a cross-sectional area of the steel monofilament constituting the belt layers and a thread count per 50 mm unit width is not less than 4.5 mm² and not more than 6.1 mm².

6. The pneumatic radial tire for use on passenger cars according to claim 1, wherein a strength of the steel monofilament constituting the belt layers is not less than 3,500 MPa, and a product of a cross-sectional area of the steel monofilament constituting the belt layers and a thread count per 50 mm unit width is not less than 4.5 mm² and not more than 5.5 mm².

7. The pneumatic radial tire for use on passenger cars according to claim 1, wherein a bundle including from two to five cords arranged in the tire width direction of the steel monofilament constituting the belt layers is disposed as a unit in the belt layers.

8. The pneumatic radial tire for use on passenger cars according to claim 1, wherein the steel cords constituting the belt auxiliary layer are formed by twisting together two or more wires.

9. The pneumatic radial tire for use on passenger cars according to claim 1, wherein the belt auxiliary layer is divided in the tire width direction and a width of each section of the belt auxiliary layer is not less than 30 mm.

10. The pneumatic radial tire for use on passenger cars according to claim 9, wherein a separation distance between the sections of the belt auxiliary layer is not less than 20% of a width of the belt layer having the smallest width of the belt layers.

11. The pneumatic radial tire for use on passenger cars according to claim 9, wherein a coat compound constituting the belt layers has a dynamic elastic modulus E′ at 20° C. of not more than 15 MPa and a tan δ at 60° C. of not more than 0.15.

12. The pneumatic radial tire for use on passenger cars according to claim 9, wherein a separation distance between the sections of the belt auxiliary layer is not less than 20% of a width of the belt layer having the smallest width of the belt layers and is not more than 60% of the width of the belt layer having the smallest width.

13. The pneumatic radial tire for use on passenger cars according to claim 1, wherein a width of the belt auxiliary layer is greater than a width of the belt layer having the smallest width of the belt layers minus 60 mm.

14. The pneumatic radial tire for use on passenger cars according to claim 1, wherein a strength of the steel monofilament constituting the belt layers is not less than 3,500 MPa and is not greater than 4,200 MPa.

15. The pneumatic radial tire for use on passenger cars according to claim 1, wherein the steel cords in the belt layers are disposed at equal spacing in the tire width direction in a meridian cross-section.

16. The pneumatic radial tire for use on passenger cars according to claim 1, wherein bundles of two to five of the steel cords are disposed in the belt layers as a unit and are aligned in the tire width direction in a meridian cross-section.

17. The pneumatic radial tire for use on passenger cars according to claim 1, wherein the steel cords of the belt auxiliary layer are formed by twisting from two to seven wires together, and a thread count of the steel cords of the belt auxiliary layer is from 15 to 35 cords/50 mm.

18. The pneumatic radial tire for use on passenger cars according to claim 1, wherein a coat compound constituting the belt layers has a same dynamic elastic modulus E′ and tan δ as the belt layers.
